(19) United States
(12) Patent Application Publication
(10) Pub. No.: US 2025/0229386 A1
(43) Pub. Date: Jul. 17, 2025

(54) ADJUSTABLE WRENCH

(71) Applicant: Milwaukee Electric Tool Corporation, Brookfield, WI (US)

(72) Inventor: Keil James Brady, Hawthorn Woods, IL (US)

(21) Appl. No.: 19/009,732

(22) Filed: Jan. 3, 2025

Related U.S. Application Data
(60) Provisional application No. 63/620,073, filed on Jan. 11, 2024.

(51) Int. Cl. B25B 13/32; B25B 13/34; B25B 13/46; B25B 21/00

(52) U.S. Cl. CPC B25B 13/32; B25B 13/34; B25B 13/463; B25B 21/004

(57) ABSTRACT

An output assembly for a power tool includes a housing having a plurality of first teeth, an outer ring that is rotatably coupled to the housing, and a jaw assembly defining an aperture with an adjustable size that is configured to receive a fastener. The jaw assembly includes a plurality of jaw pieces that are moveably coupled to the outer ring so that rotation of the outer ring is configured to move the plurality of jaw pieces relative to one another to adjust the size of the aperture to conform with the fastener received therein and to rotate the jaw assembly about a rotation axis to apply a torque to the fastener.

### CROSS-REFERENCE TO RELATED APPLICATIONS

This application claims the benefit of U.S. Provisional Patent Application No. 63/620,073, filed Jan. 11, 2024, the disclosures of which are hereby incorporated by reference in its entirety.

### BACKGROUND

Wrenches can be used to rotate a fastener (e.g., bolt, nut, etc.) by controlling tension (e.g., torque, tightness) of the fastener. The wrenches can be sized to accommodate different sizes of the fastener.

### SUMMARY

Some embodiments of the disclosed technology provide a power tool that includes an output assembly configured to accommodate a variety of different types or sizes of fasteners. In some cases, the power tool is a wrench with an adjustable aperture that can open and close to engage a range of differently size fasteners. Operation of the power tool can cause the aperture to close to engage a fastener and to rotate for tightening or loosening of the fastener. The aperture can be defined by a plurality of jaws that are movable relative to one another to change the size of the aperture. In some cases, operation can occur in two steps, with a first rotation (e.g., a first number of full or partial rotations) closing the aperture onto a fastener and a second rotation (e.g., a first number of full or partial rotations) causing rotation of the fastener.

In some non-limiting examples, an output assembly for a power tool includes a housing, an outer ring rotatably coupled to the housing, and a jaw assembly defining an aperture with an adjustable size that is configured to receive a fastener. The jaw assembly includes a plurality of jaw pieces that are moveably coupled to the outer ring so that rotation of the outer ring is configured to move the plurality of jaw pieces relative to one another to adjust the size of the aperture to conform with the fastener received therein and to rotate the jaw assembly about a rotation axis to apply a torque to the fastener.

In some cases, below a predetermined torque threshold of a torque that is applied to the outer ring, the rotation of the outer ring can move the plurality of jaw pieces to adjust the size of the aperture. In some cases, above the predetermined torque threshold, the rotation of the outer ring can rotate the jaw assembly to apply the torque to the fastener.

In some cases, the jaw pieces can be coupled to an inner ring that includes first teeth that are configured to ratchetingly engage second teeth of the housing.

In some cases, below the predetermined torque threshold, engagement of the first teeth with the second teeth can hold the inner ring stationary to cause the jaw pieces to move to change the size of the aperture. Above the predetermined torque threshold, the first teeth can slip past the second teeth to allow the outer ring to rotate the jaw assembly to apply the torque to the fastener.

In some cases, the inner ring can include a guide element that engages with the housing, such that the guide element guides a movement of the inner ring relative to the housing.

In some cases, the plurality of jaw pieces can include a slot that moveably receive a pin that is coupled to the inner ring.

In some cases, the outer ring can include a gear that transmits torque from a motor to the jaw assembly to move the plurality of jaw pieces radially relative to the rotational axis and to rotate the plurality of jaw pieces about the rotational axis.

In some cases, the motor can be coupled to the outer ring via a geartrain.

In some cases, each jaw piece of the plurality of jaw pieces can be coupled to the outer ring by a link that is pivotally coupled to the respective jaw piece and pivotally coupled to the outer ring.

In some cases, the plurality of jaw pieces can include a first jaw piece and a second jaw piece that each include a first side and a second side. The first side of the first jaw piece can slidably couple with the second side of the second jaw piece.

In some cases, the first side can include a rail and the second side can include a channel so that the channel of the first jaw piece can slidably receive the rail of the second jaw piece.

In some cases, a spring can be retained in the channel of the first jaw piece by the rail of the second jaw piece to bias the rail out of the channel.

In some cases, the plurality of jaw pieces can include an engagement surface that defines the aperture.

According to some embodiments of the disclosed technology, a power tool is provided. The power tool can include a motor and an output assembly to receive a torque from the motor. The output assembly can include a jaw assembly that defines an adjustable aperture that includes a central axis and a ring that is coupled to the jaw assembly and transitions between a locked configuration and an unlocked configuration based on the torque applied to the jaw assembly. The jaw assembly can move radially relative to the central axis to adjust a size of the aperture in the locked configuration. The jaw assembly can rotate about the central axis with the ring in the unlocked configuration.

In some cases, the output assembly can further include a plate that is rotationally fixed relative to the central axis. The plate can include first teeth. The ring can include second teeth that rotationally lock with the first teeth in the locked configuration and ratchetingly engage with the second teeth in the unlocked configuration.

In some cases, the torque that is applied to the jaw assembly can be transmitted to the ring so that, when the torque applied to the jaw assembly reaches a threshold torque, the first teeth can cause the second teeth to resiliently flex so that the ring and the jaw assembly rotate about the central axis.

In some cases, the output assembly can include an outer ring that receives the torque from the motor. The jaw assembly can be moveably coupled to the output assembly so that the output assembly can rotate relative to the jaw assembly and the ring and in the locked configuration. The output assembly can rotate with the jaw assembly and the ring and in the unlocked configuration.

In some cases, the output assembly can include a biasing assembly to bias the jaw assembly in a radial direction when zero torque is applied to the output assembly by the motor.

Some embodiments of the disclosed technology provide a method of operating an adjustable wrench. A drive ring can be rotated with a lock ring in a locked configuration to cause a plurality of jaw pieces to move in a first radial direction relative to an axis of rotation of the drive ring to engage the plurality of jaw pieces with a fastener. The drive ring can be rotated in an unlocked configuration to cause the plurality of jaw pieces to rotate with the drive ring about the axis of rotation to apply a torque to the fastener.

In some cases, rotation of the drive ring can be stopped so that a biasing assembly causes the plurality of jaw pieces to move in a second radial direction to disengage the plurality of jaw pieces with the fastener.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is an axonometric view of a non-limiting example of a power tool including an adjustable output assembly, according to aspects of the present disclosure.

FIG. 2 is an exploded axonometric view of the output assembly of the power tool of FIG. 1.

FIG. 3 is a partial cross-sectional view of the output assembly of FIG. 1, showing details of a jaw assembly of the output assembly of FIG. 1.

FIG. 4 is another partial cross-sectional view of the output assembly of FIG. 1, showing details of the jaw assembly of FIG. 3.

FIG. 5 is an axonometric view of a jaw piece of the jaw assembly of FIG. 3.

FIG. 6 is yet another partial cross-sectional view of the output assembly of FIG. 1, showing details of an inner ring of the output assembly of FIG. 1.

### DETAILED DESCRIPTION

Disclosed embodiments will now be described more fully hereinafter with reference to the accompanying drawings, in which some, but not all of the disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art.

The following detailed description is to be read with reference to the figures, in which like elements in different figures have like reference numerals. The figures, which are not necessarily to scale, depict selected examples and are not intended to limit the scope of examples of the invention. Skilled artisans will recognize the examples provided herein have many useful alternatives and fall within the scope of examples of the invention.

The disclosed power tool will be described with respect to an example wrench. However, it should be understood that any one or more example embodiments of the disclosed wrench could be incorporated in alternate forms of a power tool. Furthermore, it should be understood that one or more example embodiments of the disclosed power tool could be used outside of the context of a wrench and could more generally be used in a mechanism and/or mechanisms that tightens bolts.

In one example, the wrench described below is battery-powered and configured to tighten a fastener (e.g., nut, bolt, etc.). In general, a battery-powered wrench includes a housing that houses a motor. The motor can be operatively coupled to an output assembly (e.g., a tool head) having an output end (e.g., a socket) that is configured to engage with and apply a torque to a fastener. In some examples, an output assembly can include an inner assembly that includes a jaw assembly. The jaw assembly can include jaw pieces that are configured to move relative to one another and to form an aperture. As a geartrain transmits torque from the motor to the output assembly, a size of the aperture can change to conform with a size of the fastener. Interfaces of the jaw pieces can be configured to engage with the fastener (e.g., a head of bolt).

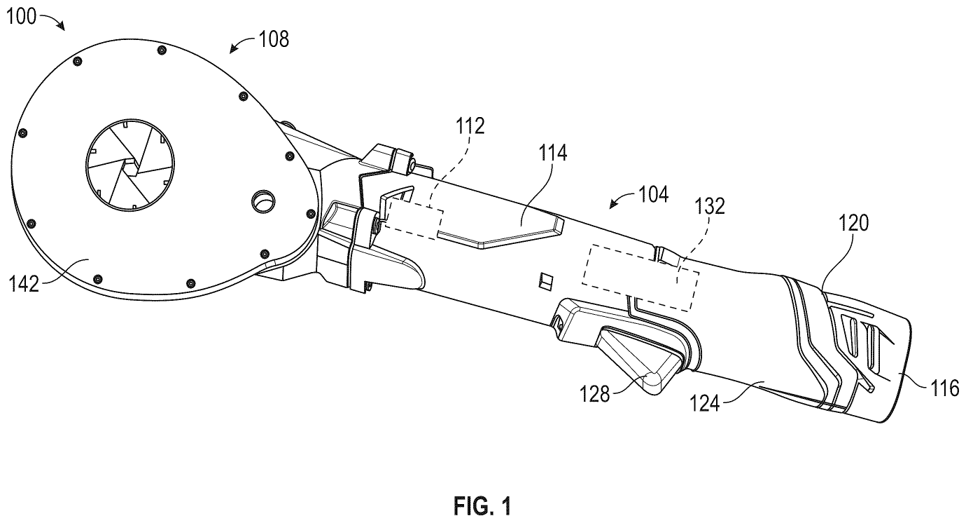

To that end, FIG. 1 illustrates a non-limiting example of a power tool 100 according to aspects of the disclosure. As illustrated, the power tool 100 is configured as a wrench, but the principles described herein can also be applied to other type of power tools (e.g., drills, impact wrenches, etc.). In general, the power tool 100 can include a tool body 104 and an output assembly 108 secured to (e.g., above) the tool body 104. The tool body 104 can have a clamshell construction with a first half and a second half that are joined together, or it can be a unitary body. In either case, the tool body 104 can define an interior space in which various components can be housed. In some cases, the output assembly 108 can be removably attached to the tool body 104 via fasteners, press-fit elements, adhesives, etc. or retrofitted onto the tool body 104 as desired. In some cases, the output assembly 108 can be configured as a hand-held wrench or a measuring gauge for fastener sizes (e.g., for threads, nuts, or pipes).

In particular, the tool body 104 can include a motor housing 114 configured to house a motor 112 (e.g., a brushless DC motor) that can be operatively coupled to supply a torque to the output assembly 108. In the illustrated example, the motor 112 is oriented horizontally (e.g., along a longitudinal direction of the tool body 104), but it may alternatively be oriented vertically. The motor 112 can be powered by a power source 116. In the illustrated example, the power source is configured as a battery, and more specifically a lithium-ion battery. The power source 116 can be coupled to the tool body 104 at a connection port 120, which, as illustrated here, can be positioned at a bottom of the tool body 104 (e.g., an end of the tool body 104 opposite the output assembly 108). In other cases, different types of power sources can be provided, including, for example, a power cord configured to supply AC electrical power. In some cases, the output assembly 108 can be manually operated without the motor 112. In some cases, a display can be provided on the power source 116 or the tool body 104 to indicate a charge state of the power source 116.

To control a flow of power to the motor 112, the tool body can further include a user interface, here, configured as a handle 124. The handle 124 can provide a location whereby a user can grip and manipulate the power tool 100. Additionally, the handle 124 can include one or more triggers 128 to control the flow of power from the power source 116 to the motor 112. For example, depressing a trigger 128 can send a signal to a controller 132. The controller 132 can receive the signal and control the flow of power from the power source 116 to the motor 112. Supplying power to the motor 112 can cause the motor 112 to spin to supply a torque to the output assembly 108 to tighten a fastener. In some cases, the signal from the trigger 128 to the controller 132 can be associated with an amount of torque to the output assembly 108 or a level of desired tightness for a fastener. In some cases, the signal to the controller 132 can be associated with a speed of the motor 112.

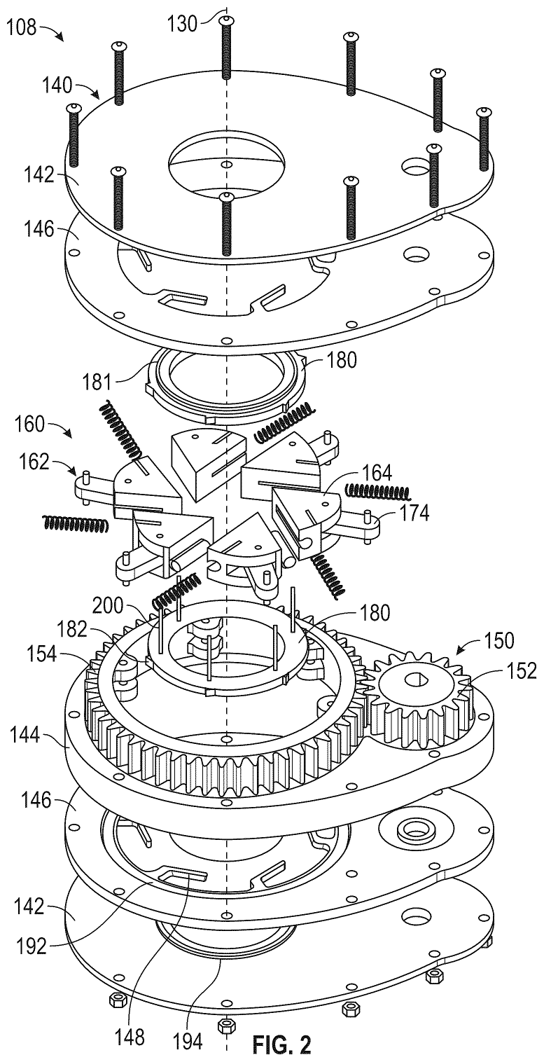

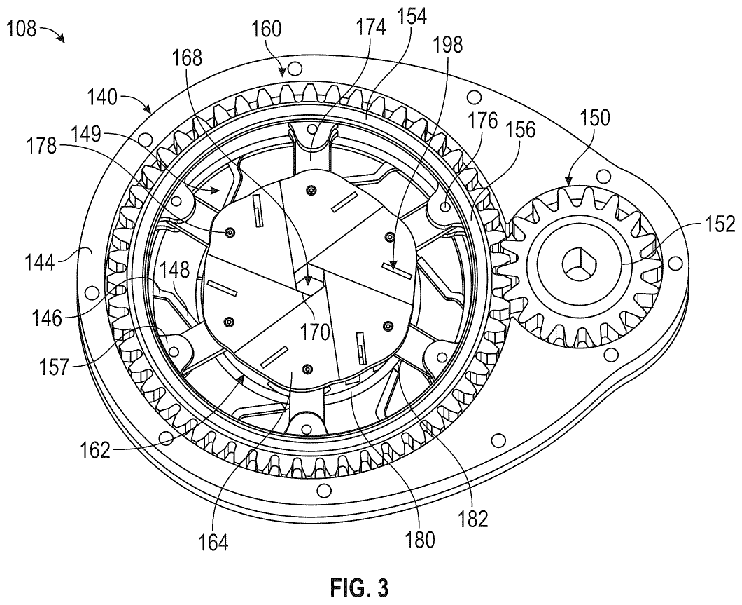

As generally discussed above, a power tool can be configured as an adjustable wrench that can engage with a range of differently sized or shaped fasteners with a single output assembly. Correspondingly, the output assembly can include movable jaws (e.g., jaw pieces) that define an aperture to receive a fastener. The jaws can move relative to one another to adjust the size the aperture so that the jaws engage the fastener. For example, FIGS. 2-4 illustrate details of the output assembly 108. The output assembly 108 can include a housing 140 that includes an outer casing 142 (also depicted in FIG. 1), an inner casing 144, and a plate 146 that can be positioned between the outer casing 142 and the inner casing 144. As shown in FIG. 2, the housing 140 includes two sets of the outer casing 142 and the plate 146 that are substantially similar to one another and are arranged on opposite sides (e.g., upper and lower sides) of the output assembly 108. In the illustrated example, the outer casing 142, the inner casing 144, the plate 146 are coaxially aligned along a rotational axis 130 (e.g., a central axis). For simplicity, one set of the outer casing 142 and the plate 146 are discussed below, and the discussion similarly applies to the other set of the outer casing 142 and the plate 146.

The output assembly 108 can further include a geartrain 150 that is configured to transmit operational power (e.g., torque) from the motor 112 to the output assembly 108 to cause the output assembly 108 to engage and rotate a fastener. In other examples, more than one motor can be configured to cause the output assembly 108 to engage and rotate a fastener. As illustrated, the geartrain 150 includes a first gear 152 and a second gear 154. In other examples, the geartrain 150 can be configured differently, for example, to include bevel gears, planetary gears, jackshafts, etc. The geartrain 150 can be positioned within the housing 140. In particular, the inner casing 144 defines an opening 149 that is sized to receive the geartrain 150, and the plate 146 that is configured to support the geartrain 150. For example, the plate 146 can include a recessed ring 192 that supports a corresponding protruded ring 156 of the second gear 154. Accordingly, the second gear 154 and one or more of the plate 146, the inner casing 144, or the outer casing 142 can be coaxially aligned. The second gear 154 can include a second protruded ring (e.g., substantially similar to the protruded ring 156) on an opposite side of the second gear 154 to be supported by a corresponding recessed ring of a second plate. In an assembled configuration, the motor 112 of the power tool 100 can engage with the first gear 152 (e.g., via a motor shaft of the motor 112) to transmit a torque to the second gear 154 to operate the output assembly 108. While two gears are provided in the illustrated example, other configurations can include one gear or a greater number of gears (e.g., three, four, five, etc.) to operate the output assembly 108.

The output assembly 108 includes an inner assembly 160 with a jaw assembly 162 that defines an aperture 168 (e.g., an adjustable aperture). The jaw assembly 162 includes a plurality of jaw pieces 164 that collectively define the aperture 168 and are configured to move relative to one another to adjust a size of the aperture 168 to correspond with a fastener that is being engaged (e.g., tightened or loosened). The jaw pieces 164 can be shaped or arranged to engage with various types of fasteners, including for example, square, hexagonal, 12-point, etc. In the illustrated example, the output assembly 108 include six jaw pieces 164 that are shaped and arranged to define a hexagonal aperture 168. In other examples, more or fewer jaw pieces can be provided (e.g., two, three, four, five, seven, eight, etc.).

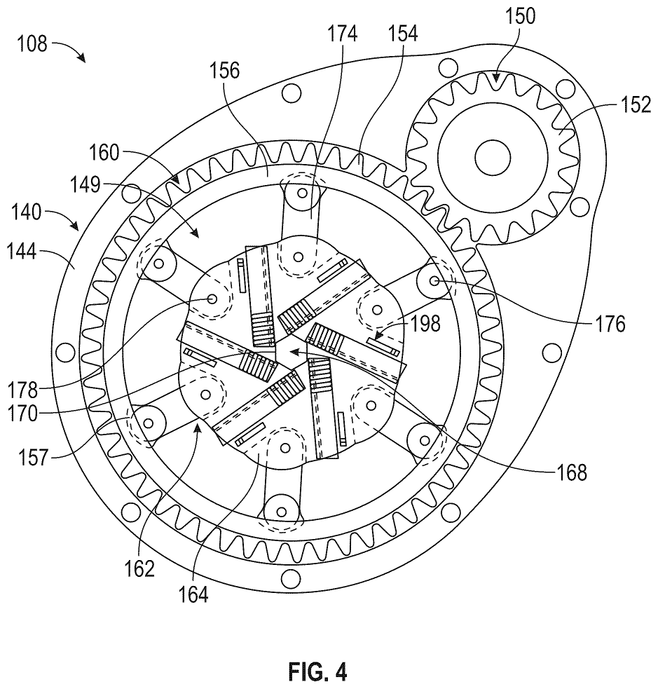

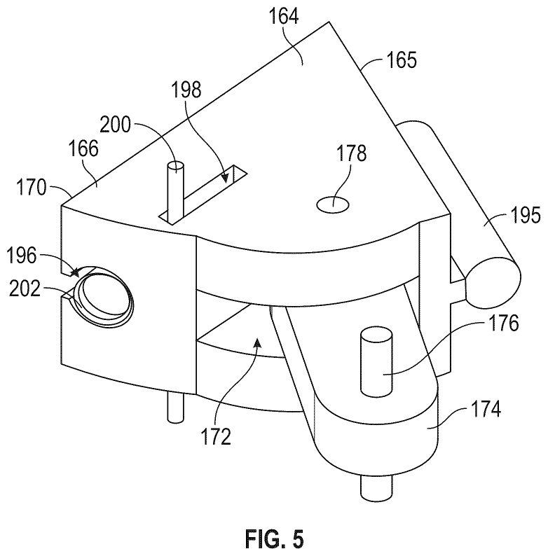

As illustrated in FIGS. 4 and 5, each of the jaw pieces 164 can have a first side 165 and a second side 166 that are each configured to engage with an adjacent jaw piece 164. In particular, the first side 165 can include a rail 195 (e.g., a guide rail), and the second side 166 can include a channel 196 that is configured to receive a rail 195 of a neighboring jaw piece 164. Each rail 195 can slide within a corresponding channel 196 (e.g., as shown in FIG. 4) to allow the jaw pieces 164 to move relative to one another to change the size of the aperture 168 between a maximum size and a minimum size. Engagement between the rails 195 and the channels 196 helps maintain the spatial relationship of jaw pieces 164 with respect to one another so that the shape of the aperture 168 is maintained as the jaw pieces 164 move relative to one another to change the size of the aperture 168. In some cases, a spring 202 (e.g., a biasing assembly, bushing, resilient member, etc.) can be positioned within the channel 196 to bias movement of the jaw pieces 164. For example, when the motor 112 is operated to move the jaw pieces 164 to close the aperture 168, the rail 195 can move into the channel 196 to compress the spring 202. Upon ceasing operation of the motor 112 (e.g., to stop applying torque to the output assembly), the spring 202 can uncompress, pushing the rail 195 out of the channel 196 to move the jaw pieces 164 and open the aperture 168. In some cases, the spring 202 can bias the jaw pieces 164 in a radial direction when zero torque is applied to the output assembly 108 by the motor 112.

A jaw piece for a jaw assembly can also define an engagement surface 170 that is configured to engage with and apply a force to a fastener. The engagement surface 170 defines the boundaries and shape of the aperture 168. In the illustrated example, the jaw pieces 164 have triangle-like shape, in which the second side 166 of each jaw piece 164 forms the engagement surface 170 that defines a side of the aperture 168. In other examples, a jaw piece may define a separate engagement surface 170. In some cases, the first side 165 of each jaw piece 164 can form the engagement surface 170. In other examples, a jaw piece can be shaped as other types of polyhedron or geometric shapes with varying parameters. Moreover, while the illustrated jaw pieces 164 are substantially identical to one another, in other examples, jaw pieces with different shapes can be used together. Further, while the illustrated example includes the first side 165 that is shorter in length than the second side 166, other configurations can include the first side 165 that is longer in length than the second side 166. In some cases, dimensions of the jaw pieces 164 (e.g., height, length, an angle between sides) can be adjusted to achieve a desired movement of each jaw piece 164 relative to the adjacent jaw pieces 164, a torque profile generated by a movement of the jaw pieces 164, or a shape of the aperture 168.

Continuing, the geartrain 150 can be configured to engage with the inner assembly 160 to initiate a movement of the jaw assembly 162 (e.g., movement of one or more jaw pieces 164). In particular, with additional reference to FIG. 5, the jaw piece 164 can include a hole 172 that is configured to receive a link 174. The link 174 can be secured to the jaw piece 164 via a first pin 178 and to the second gear 154 via a second pin 176. Accordingly, the link 174 can rotatably engage with the jaw piece 164 via the first pin 178 and with the second gear 154 via a second pin 176 (e.g., at a tab 157 on a radially inner surface of the second gear 154). Thus, the link 174 can rotatably engage with the jaw piece 164 and the second gear 154 as the link 174 pivots about the first pin 178 and the second pin 176. For example, as the second gear 154 rotates relative to the housing 140 about the rotational axis 130, the link 174 transmits rotational force from the second gear 154 to the jaw piece 164, which causes the jaw piece 164 to move (e.g., radially inward relative to the second gear 154) to change the size of the aperture 168. Once the jaw pieces 164 engage with a fastener, continued rotation of the second gear 154 causes the jaw pieces 164 to rotate in the same direction as the second gear 154 to tighten or loosen the fastener (e.g., depending on which side the fastener is inserted into the aperture from).

To control movement of the jaw pieces 164, the jaw pieces 164 can be coupled to an inner ring 180 (e.g., a ratchet ring, a lock ring, a holding ring, etc.). For example, each jaw piece 164 can include a slot 198 that is configured to receive a rod 200 that is fixed to the inner ring 180. In some cases, the inner ring 180 can include a corresponding aperture to receive the rod 200 and removably attach the rod 200 to the inner ring 180. When the inner ring 180 is stationary relative to the housing 140, rotation of the second gear 154 (e.g., an outer ring or a drive ring) applies a corresponding force to the jaw pieces 164 via the links 174. The applied force induces movement of the jaw piece 164 which is constrained by the interaction of the rod 200 in the slot 198. Specifically, the slot 198 is shaped so that the jaw pieces 164 move radially (e.g., partially, or entirely radially) to change (e.g., shrink) the size of the aperture 168 to conform with a fastener. In some cases, the movement of the jaw pieces 164 can be controlled by a length and shape of the slots 198. Correspondingly, when the inner ring 180 is allowed to rotate relative to the housing 140 about the rotational axis 130, rotation of the second gear 154 applies a corresponding force to the jaw pieces 164 via the links 174, which can cause the jaw pieces 164 to rotate with the second gear 154 about the rotational axis 130 for applying a torque to a fastener. As the jaw pieces 164 rotate, the jaw pieces 164 can induce a corresponding rotation in the inner ring 180 via the connection to the rods 200. Once rotation of the second gear 154 ceases, the springs 202 can push the jaw pieces 164 radially outward to open the aperture 168, which induces a corresponding rotation of the inner ring 180 (e.g., relative to the second gear 154). While the illustrated example shows the slots 198 have an elongated rectangular shape, other examples can include slots that are defined by different shapes, including ovular, triangular, polygonal, circular, etc. In some cases, dimensions and shapes of the slots 198 can be selected to induce a desired range of movement of the jaw pieces 164.

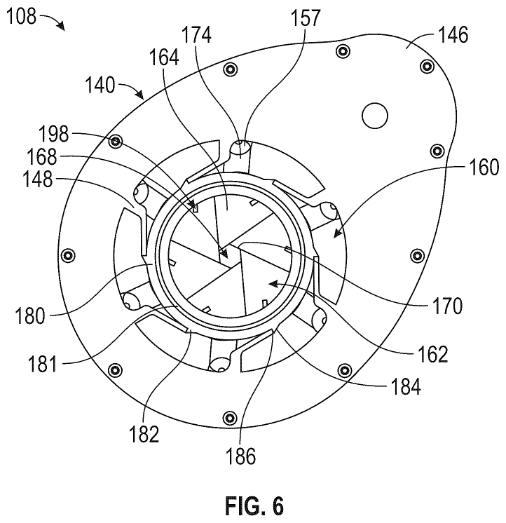

In some cases, the housing 140 can be configured to selectively engage with the inner ring 180 to lock rotation of the inner ring 180 in a locked configuration and unlock rotation of the inner ring 180 in an unlocked configuration. In this way, the output assembly 108 can automatically control movement of the inner ring 180 to switch between adjusting a size of the aperture 168 onto a fastener and applying a torque to the fastener. For example, with additional reference to FIG. 6, the inner ring 180 is configured to engage with the plate 146 of the housing 140 to control rotation of the inner ring 180. As also shown in FIG. 2, the inner ring 180 can be provided with a rail 181 (e.g., a guide element) that can engage with a corresponding channel 194 formed on a surface of the outer casing 142 that faces the plate 146. In the illustrated example, the rail 181 is shaped to maintain a motion (e.g., circular motion) of the inner assembly 160. In the illustrated example, the inner ring 180 includes the rail 181, and the outer casing 142 includes the channel 194. In other examples, the inner ring 180 and the outer casing 142 can include different guide elements that engage with one another. For example, the inner ring 180 can include a channel, and the outer casing 142 can include a corresponding rail.

In addition, the inner ring 180 includes a plurality of teeth 182 (e.g., first teeth or ratchets) that are configured to ratchetingly engage a plurality of arms 148 (e.g., second teeth or pawls) formed by the plate 146. In this case, the teeth 182 extend radially outward from the inner ring 180, and the arms 148 extend radially inward from the plate 146. Each tooth 182 includes a leading surface 184 that is configured to engage with the arms 148. Here, the leading surfaces 184 are angled to allow the teeth 182 to slip past the arms 148 when a torque on the inner ring 180 reaches a predetermined torque threshold. In particular, the teeth 182 can include a generally triangular shape, and the leading surfaces 184 can extend at an acute angle relative to rear surfaces 186. In some cases, the leading surfaces 184 can extend at an angle less than 30° relative to the rear surfaces 186, at an angle less than 60° relative to the rear surfaces 186, at an angle less than 90° relative to the rear surfaces 186. In the illustrated example, the plurality of teeth 182 includes six teeth, and the plurality of arms 148 includes six arms. In other embodiments, the plurality of teeth 182 can include a fewer or greater number of teeth (e.g., one, two, three, four, five, seven, eight, nine, etc.) and the plurality of arms 148 can include a fewer or greater number of arms (e.g., one, two, three, four, five, seven, eight, nine, etc.). In some cases, the number of teeth and arms can be associated with a reduced engagement angle (e.g., an amount of rotation required to engage a subsequent tooth) of tightening or loosening torque on a fastener. Further, while the inner ring 180 is illustrated to include a rail in the present embodiment, other embodiments can include the inner ring 180 having a channel and the outer casing 142 having a corresponding rail.

Accordingly, below the predetermined torque threshold, engagement of the teeth 182 with the arms 148 can hold the inner ring 180 stationary (e.g., in a locked configuration) to cause the jaw pieces 164 to move to shrink the aperture 168 and engage a head of the fastener. Engagement of the jaw pieces 164 on the fastener can prevent the jaw pieces 164 from moving inward and cause the torque on the inner ring 180 to build. Once the torque on the inner ring 180 reaches the predetermined torque threshold, the teeth 182 and arms 148 can (e.g., ratchetingly) slip past one another, allowing the second gear 154 to rotate the jaw pieces 164 to apply a tightening or loosening torque to the fastener. For example, the angled leading surfaces 184 of the teeth 182 can resiliently flex the arm 148 in a radially outward direction until the teeth 182 move past the arm 148.

Still referring to FIG. 6, to apply a torque to a fastener, a head of the fastener can be positioned within the aperture 168. In some cases, the fastener may have a size that is less than a size of the aperture 168. Accordingly, the jaw pieces 164 may not be engaged with the fastener. To engage the jaw pieces 164 on the fastener, the motor 112 can be operated to rotate the second gear 154. If the jaw pieces 164 are not in contact with the fastener (e.g., not fully engage to apply a tightening or loosening torque), the jaw pieces 164 are free to rotate with the second gear 154 in a first rotational direction (e.g., anti-clockwise with respect to FIG. 6). As described above, rotation of the jaw pieces 164 induces corresponding rotation of the inner ring 180 in the first rotational direction, until the leading surfaces 184 of the teeth 182 engage the arms 148, stopping the rotational motion of the inner ring 180. In some cases, the inner ring 180 may not rotate at the same rotational speed as the jaw assembly 162, as a force to push the arms 148 of the plate 146 can be greater than a force to compress the springs 202 within the jaw piece 164 as the jaw assembly 162 rotates.

Once the inner ring 180 is held stationary via engagement of the teeth 182 with the arm 148, continued rotation of the second gear 154 causes the jaw pieces 164 to move relative to one another to close the aperture 168 on the fastener. As discussed above, this movement of the jaw pieces 164 can compress the springs 202. With the jaw pieces 164 engaged on the fastener, continued rotation of the second gear 154 builds torque on the inner ring 180. The torque generated by the first gear 152 is transferred to the inner ring 180 through the jaw assembly 162, urging the teeth 182 to overcome a reaction force of the arms 148, which flexes the arms 148 radially outward to allow the inner ring 180 to rotate. Accordingly, the jaw assembly 162 and the inner ring 180 can rotate with the second gear 154 (e.g., in an unlocked configuration), allowing the second gear 154 to apply a tightening or loosening torque to the fastener.

To release or disengage the fastener, operation of the motor 112 can be ceased so that the second gear 154 is stationary and torque is no longer transmitted the jaw assembly 162. Accordingly, the springs 202 can uncompress, which causes the jaw pieces 164 to move radially outward, opening the aperture 168 (e.g., to increase a size thereof) and disengaging the jaw pieces 164 from the fastener. In some cases, this movement of the jaw pieces 164 can cause the inner ring 180 to rotate in a second rotational direction that is opposite the first rotational direction (e.g., clockwise with respect to FIG. 6). The inner ring 180 may rotate in the second rotational direction until the teeth 182 engage with the arms 148. For example, the rear surfaces 186 of the teeth 182 can engage the arms 148. The increased size of the aperture 168 allows the fastener to be removed from the power tool 100.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

Also as used herein, unless otherwise specified or limited, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “a single one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, unless otherwise noted, features or functionality of any particular example presented herein can be substituted into or otherwise combined with other examples, including to supplement or replace various features or functionality of the other examples.

Likewise, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise limited or specified, “substantially identical” refers to two or more components or systems that are manufactured according to the same process and specification, with variation between the components or systems that are within the limitations of acceptable tolerances for the relevant process or specification. For example, two components can be considered to be substantially identical if the components are manufactured according to the same standardized manufacturing steps, with the same materials, and within the same acceptable dimensional tolerances (e.g., as specified for a particular process or product).

Additionally, unless otherwise specified or limited, “substantially coaxial” indicates that the described elements have axes that are substantially parallel with each other and are aligned so that extension of the axis of one of the elements intersects an axial end of another of the elements (e.g., at or within a diameter or other maximum width thereof, within 50% of a diameter or other maximum width thereof, within 25% of a diameter or other maximum width thereof, or within 5%—or less—of a diameter or other maximum width thereof).

Also as used herein, unless otherwise defined or limited, directional terms are used for convenience of reference for discussion of particular figures or examples or to indicate spatial relationships relative to particular other components or context but are not intended to indicate absolute orientation. For example, references to downward, forward, or other directions, or to top, rear, or other positions (or features) may be used to discuss aspects of a particular example or figure, but do not necessarily require similar orientation or geometry in all installations or configurations.

What is claimed is:

1. An output assembly for a power tool, the output assembly comprising:
a housing;
an outer ring rotatably coupled to the housing; and
a jaw assembly defining an aperture with an adjustable size that is configured to receive a fastener, the jaw assembly including a plurality of jaw pieces moveably coupled to the outer ring so that rotation of the outer ring is configured to move the plurality of jaw pieces relative to one another to adjust the size of the aperture to conform with the fastener received therein and to rotate the jaw assembly about a rotational axis to apply a torque to the fastener.

2. The output assembly of claim 1, wherein, below a predetermined torque threshold of a torque that is applied to the outer ring, the rotation of the outer ring moves the plurality of jaw pieces to adjust the size of the aperture, and above the predetermined torque threshold, the rotation of the outer ring rotates the jaw assembly to apply the torque to the fastener.

3. The output assembly of claim 2, wherein the jaw pieces are coupled to an inner ring that includes first teeth that are configured to ratchetingly engage second teeth of the housing.

4. The output assembly of claim 3, wherein, below the predetermined torque threshold, engagement of the first teeth with the second teeth holds the inner ring stationary to cause the jaw pieces to move to change the size of the aperture, and above the predetermined torque threshold, the first teeth slip past the second teeth to allow the outer ring to rotate the jaw assembly to apply the torque to the fastener.

5. The output assembly of claim 3, wherein the inner ring includes a guide element that engages with the housing, such that the guide element guides a movement of the inner ring relative to the housing.

6. The output assembly of claim 3, wherein the plurality of jaw pieces includes a slot that moveably receives a pin that is coupled to the inner ring.

7. The output assembly of claim 1, wherein the outer ring includes a gear that transmits torque from a motor to the jaw assembly to move the plurality of jaw pieces radially relative to the rotational axis and to rotate the plurality of jaw pieces about the rotational axis.

8. The output assembly of claim 7, wherein the motor is coupled to the outer ring via a geartrain.

9. The output assembly of claim 1, wherein each jaw piece of the plurality of jaw pieces is coupled to the outer ring by a link that is pivotally coupled to the respective jaw piece and pivotally coupled to the outer ring.

10. The output assembly of claim 1, wherein the plurality of jaw pieces includes a first jaw piece and a second jaw piece that each include a first side and a second side, and
wherein the first side of the first jaw piece slidably couples with the second side of the second jaw piece.

11. The output assembly of claim 10, wherein the first side includes a rail and the second side includes a channel so that the channel of the first jaw piece slidably receives the rail of the second jaw piece.

12. The output assembly of claim 11, wherein a spring is retained in the channel of the first jaw piece by the rail of the second jaw piece to bias the rail out of the channel.

13. The output assembly of claim 1, wherein the plurality of jaw pieces includes an engagement surface that defines the aperture.

14. A power tool, comprising:
a motor; and
an output assembly to receive a torque from the motor, the output assembly including:
a jaw assembly defining an adjustable aperture having a central axis, and
a ring coupled to the jaw assembly and transitioning between a locked configuration and an unlocked configuration based on the torque applied to the jaw assembly, the jaw assembly moving radially relative to the central axis to adjust a size of the aperture in the locked configuration, and the jaw assembly rotating about the central axis with the ring in the unlocked configuration.

15. The power tool of claim 14, wherein the output assembly further includes a plate that is rotationally fixed relative to the central axis, the plate including first teeth; and
wherein the ring includes second teeth that rotationally lock with the first teeth in the locked configuration and that ratchetingly engage with the second teeth in the unlocked configuration.

16. The power tool of claim 15, wherein the torque applied to the jaw assembly is transmitted to the ring so that, when the torque applied to the jaw assembly reaches a threshold torque, the first teeth cause the second teeth to resiliently flex so that the ring and the jaw assembly rotate about the central axis.

17. The power tool of claim 14, wherein the output assembly further includes an outer ring that receives the torque from the motor, and
wherein the jaw assembly is moveably coupled to the output assembly so that the output assembly rotates relative to the jaw assembly and the ring and in the locked configuration and so that the output assembly rotates with the jaw assembly and the ring and in the unlocked configuration.

18. The power tool of claim 14, wherein the output assembly further includes a biasing assembly to bias the jaw assembly in a radial direction when zero torque is applied to the output assembly by the motor.

19. A method of operating an adjustable wrench, the method comprising:
rotating a drive ring with a lock ring in a locked configuration to cause a plurality of jaw pieces to move in a first radial direction relative to an axis of rotation of the drive ring to engage the plurality of jaw pieces with a fastener; and
rotating the drive ring with the lock ring in an unlocked configuration to cause the plurality of jaw pieces to rotate with the drive ring about the axis of rotation to apply a torque to the fastener.

20. The method of claim 19, further comprising stopping rotation of the drive ring so that a biasing assembly causes the plurality of jaw pieces to move in a second radial direction to disengage the plurality of jaw pieces with the fastener.
